(19) United States
(12) Patent Application Publication
(10) Pub. No.: US 2012/0292299 A1
(43) Pub. Date: Nov. 22, 2012

(54) ELECTRIC HEATER STRUCTURE

(76) Inventor: Shu Li HUANG, Taipei City (TW)

(21) Appl. No.: 13/459,904

(22) Filed: Apr. 30, 2012

(30) Foreign Application Priority Data
May 20, 2011 (TW) 100209092

(51) Int. Cl. H05B 3/00

(52) U.S. Cl. 219/209

(57) ABSTRACT

An electric heater structure which comprises a combined configuration of an electric heater and an electric fan device, and is characterized in that the electric fan device is configured at a lower position to bring the heated air to a farther place and to provide a better indoor circulation effect via the wind field made by the electric fan device, and thus enable the indoor space warmer and more comfortable.

### BACKGROUND OF THE INVENTION

1. Field of the Invention

The present invention is related to an electric heater structure and more particularly to a combined configuration of an electric heater and an electric fan device, which the wind field driven by the electric fan device moves the heated air to a farther place and provides the indoor space a better warm circulation and more comfortable for people living in, and is suitably applied in a variety of electric heaters and those similar electronic devices.

2. Description of Related Art

Whenever it comes the winter season or cold front, people tend to use an electric heater to keep the body felt warm or provide a warmer indoor environment. The electric heater usually only radiate the heat within a short distance and it might not be able to be a source to spread heat to a farther place. Therefore, it is both inconvenient and dangerous for people to keep too close to a heater with high temperature and stay around the limited space to catch warm. Furthermore, the prior electric heater could not offer a better power efficiency, but works as a high electric power consuming device.

Thus, in view of the above-mentioned problems, the present invention aims to provide an innovated electric heater structure which offers an electric hater device with a better heated air circulation, and is easy to be operated inside an indoor environment to enable more convenience and safety for daily lives during cold season.

### SUMMARY OF THE INVENTION

The primary objective of the present invention is to provide an electric heater structure which comprises a combined configuration of an electric heater and an electric fan device, and is characterized in that the electric fan device is configured at a lower position to bring the heated air to a farther place and to provide a better indoor circulation effect via the wind field, and thus enable the indoor space warmer and more comfortable.

An another objective of the present invention is to provide an electric heater structure, which a wind guide is configured from the top of the electric heater and extend forward, and the fore part of the wind guide is shaped as an upward front curve to enable the heated air blowing to a farther place via the front curve and provide a warmer indoor environment.

A further objective of the present invention is to provide an essence device, which is configured at the inner lower side of the wind guide to provide a fresher essence to the air through the blowing air driven by the electric fan device.

Advantageously, the present invention relates to an electric heater structure which comprises a combined configuration of an electric heater and an electric fan device, and is characterized in that an electric fan device is configured at a lower position to bring the heated air to a farther place, and thus enable a better air circulation, a fresher indoor environment, and a warmer and more comfortable space.

To enable a further understanding of the said objectives and the structural configuration of the present invention, the brief description of the drawings below is followed by the detailed description of the preferred embodiments.

### BRIEF DESCRIPTION OF THE DRAWINGS

FIG. 1 illustrates a schematic appearance of an embodiment according to the present invention;

FIG. 2 illustrates a vertical cross-section diagram of the present invention;

FIG. 3 illustrates the FIG. 2 with a wind-guide of the present invention;

FIG. 4 illustrates the FIG. 3 with a front-curve at the fore part of the wind-guide;

FIG. 5 illustrates the FIG. 4 holding with an essence device;

FIG. 6 illustrates a vertical cross-section diagram of the second embodiment;

FIG. 7 illustrates the FIG. 6 with a wind-guide of the second embodiment;

FIG. 8 illustrates the FIG. 7 with a front-curve at the fore part of the wind-guide; and

FIG. 9 illustrates the FIG. 8 holding with an essence device.

| | | | |
|---|---|---|---|
| 10 | electric heater | 11 | heated air |
| 20 | electric fan device | 21 | fan |
| 211 | wind field | 30 | wind-guide |
| 31 | front-curve | 40 | essence device |
| 50 | frame | 51 | upper room |
| 52 | lower room | | |

### DETAILED DESCRIPTION OF THE PREFERRED EMBODIMENTS

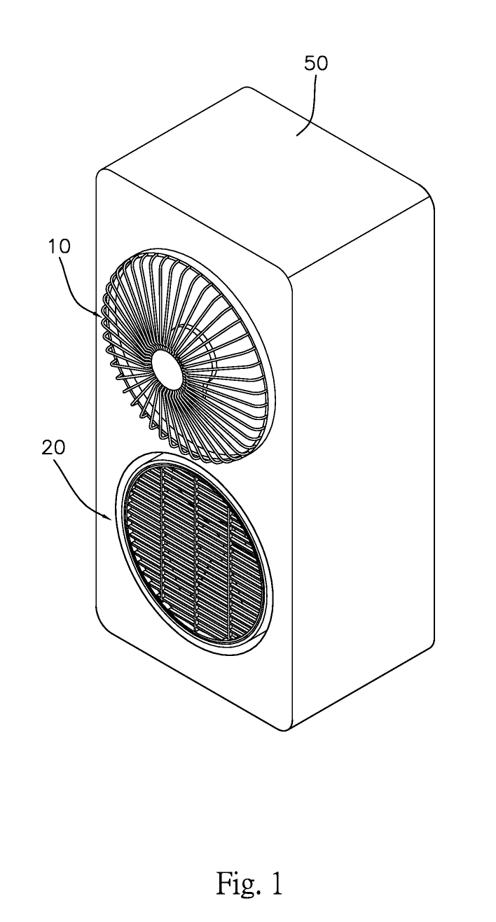

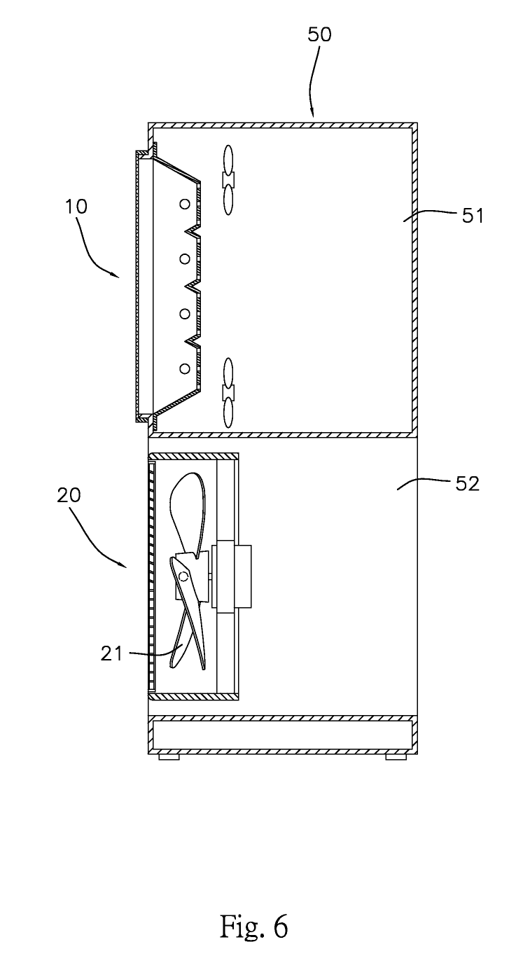

Please refer to FIGS. 1 to 9, which respectively show some schematic views and explanation related to the present invention. The present invention is related to an electric heater structure which comprises a combined configuration of an electric heater 10 and an electric fan device 20, and is characterized in that the electric fan device 20 is configured at the lower room 52 of the frame 50 (the electric heater 10 is located at the upper room 51) to bring the heated air to a farther place and to provide a better indoor circulation effect, and thus enable the indoor space warmer and more comfortable.

Meanwhile, the electric fan device 20 is configured to be adjustable to blow out the wind field 211 by its controllable direction or angle. And, a wind guide 30 is installed from the top of the electric heater 10 and extend forward, and the fore part of the wind guide 30 is shaped as an upward front curve 31 to enable the heated air could be blown via the upward curvature to a farther place. Besides, the present invention is further provides an essence device 40 which is configured at the inner lower side of the wind guide 30 to provide a fresher essence in the air through the blowing of heated air driven by the electric fan device 20.

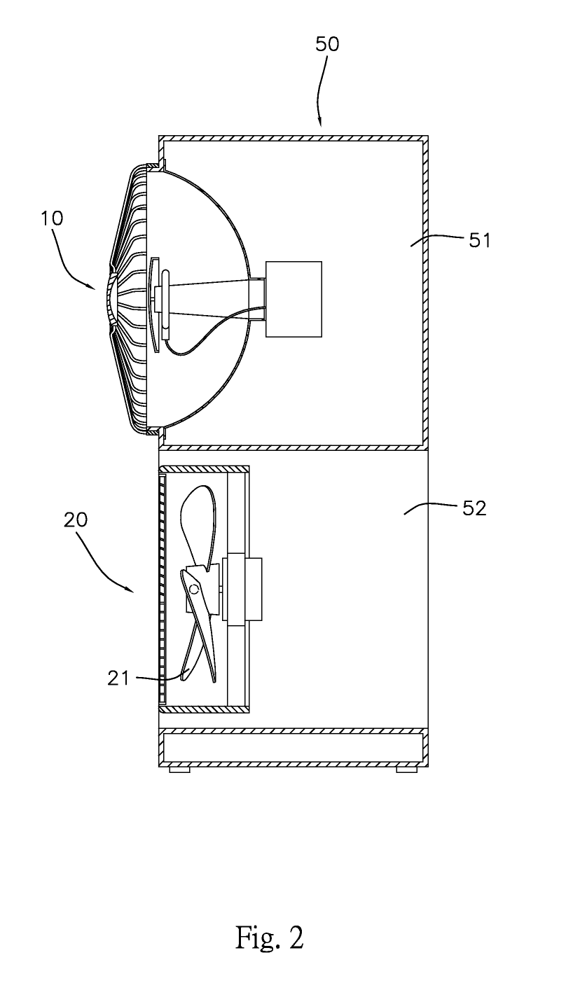

Please refer to FIGS. 1 to 9 again, those figures show some schematic diagram and embodiments related to the present invention. The first embodiment shows a combined configuration of an electric heater 10 and an electric fan device 20, which is integrally configured within a whole structure and the frame 50 is separated into an upper room 51 and a lower room 52 (as shown in FIG. 2) to accommodate the electric heater 10 and the electric fan device 20 respectively. Nevertheless, both the upper room 51 and the lower room 52 could be alternatively configured into an assembly of two sub-frames to form as a structural function (as the frame 50) with an electric heater 10 at the upper room 51 and an electric fan device 20 at the lower room 52. It's to be noted that the electric fan device 20 at the lower room 52 or lower space of the frame 50 is equipped with a structure or a function which is adjustable to blow out the wind field 211 by its controllable direction or angle.

When the power of the electric heater 10 is turned on, the heated air 11 is initially blown forward only. Then, as the electric fan device 20 is powered on and is adjusted upward for a certain angular range, for example: between 15 to 60 degrees, the fans 21 will drive a wind field 211 toward upward and therefore mix with the heated air 11 to enable a better air circulation, a fresher indoor environment, and a warmer and more comfortable space.

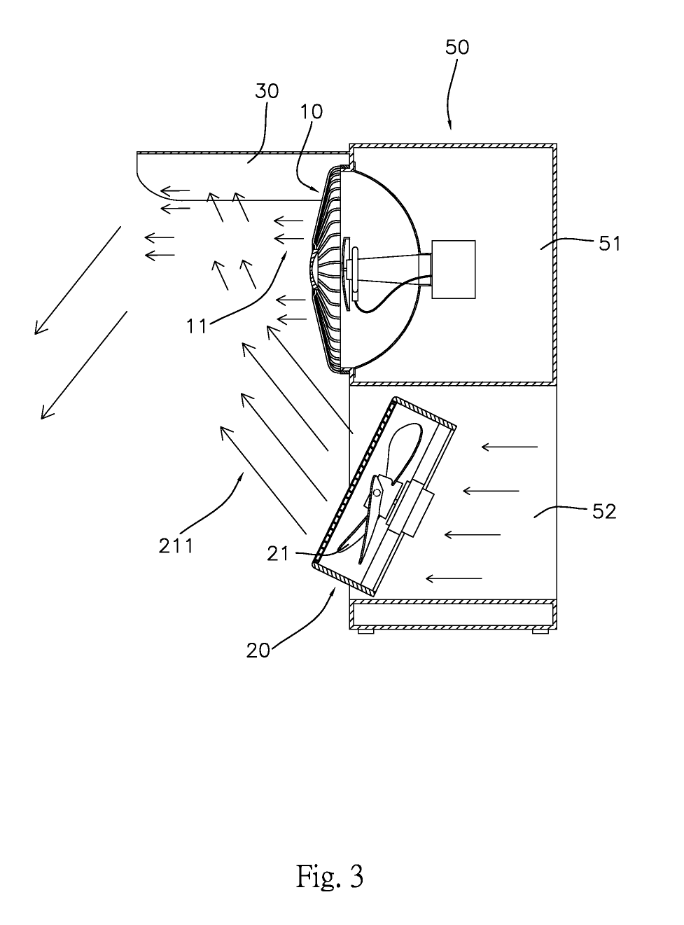

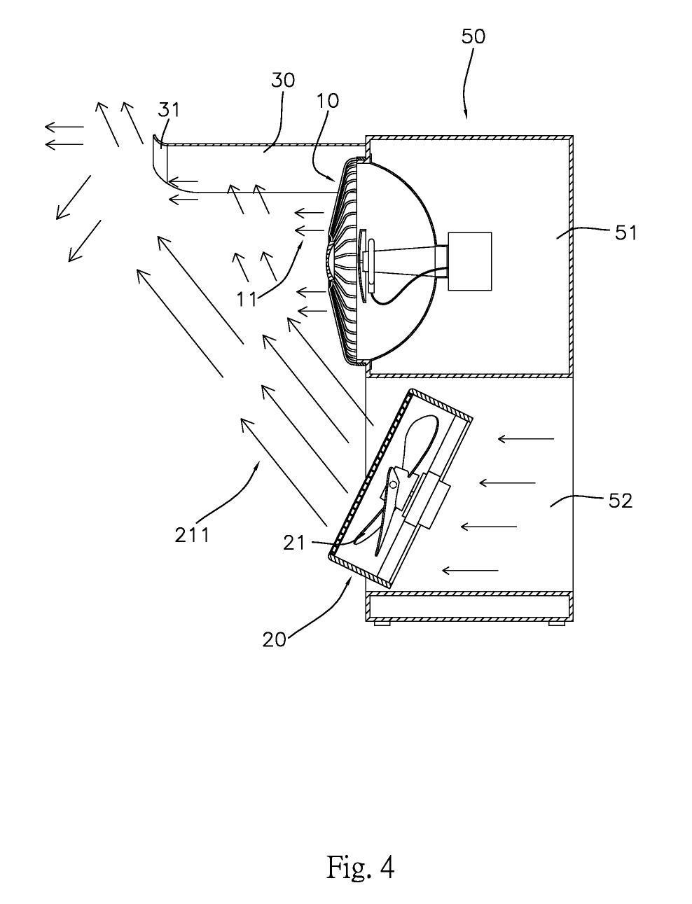

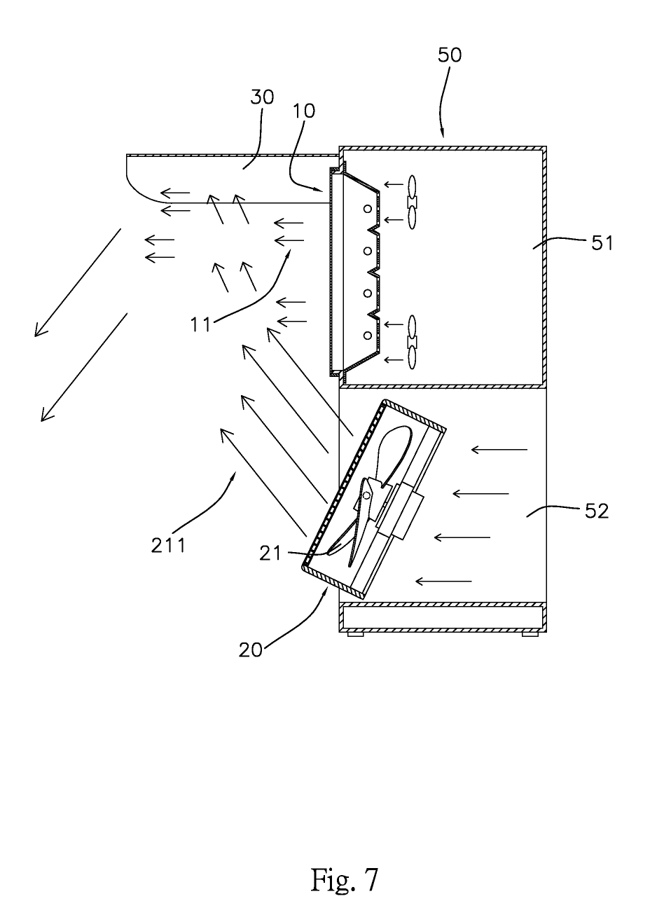

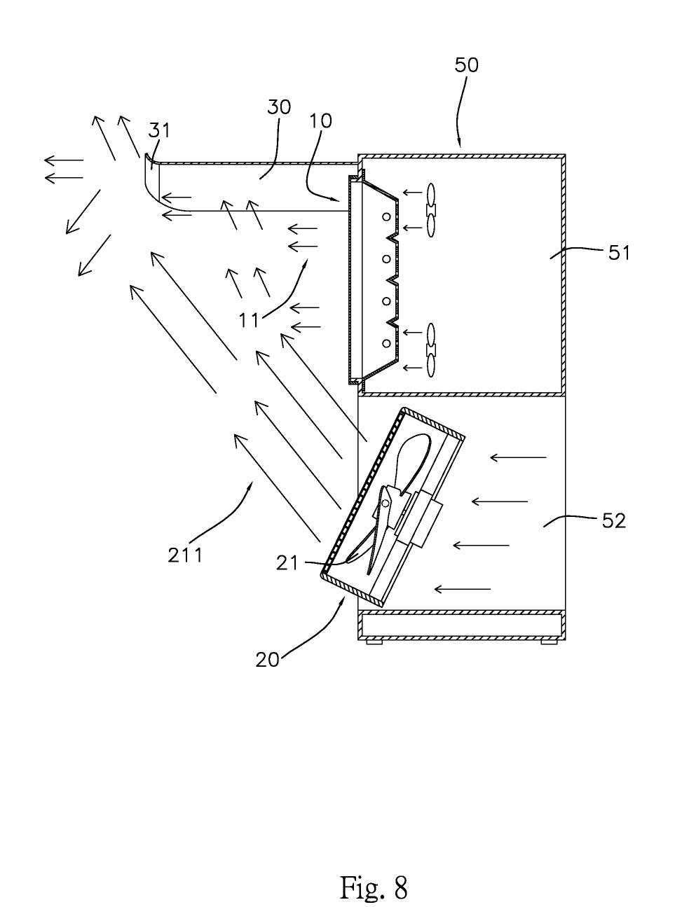

Furthermore, a wind guide 30 is installed from the top of the electric heater 10 and formed as a whole assembly with the frame 50 (as shown in FIGS. 3 and 7) or with the electric heater 10 (not shown). When the wind field 211 mixes with the heated air 11, the heated air 11 is brought to the wind guide 30 and blown via the upward curvature of front curve 31 (as shown in FIGS. 4 and 8) to a farther place. Under such a circumstance, the present invention provides a better circulation of heated air from a higher position to the whole indoor space which is warmer and more comfortable.

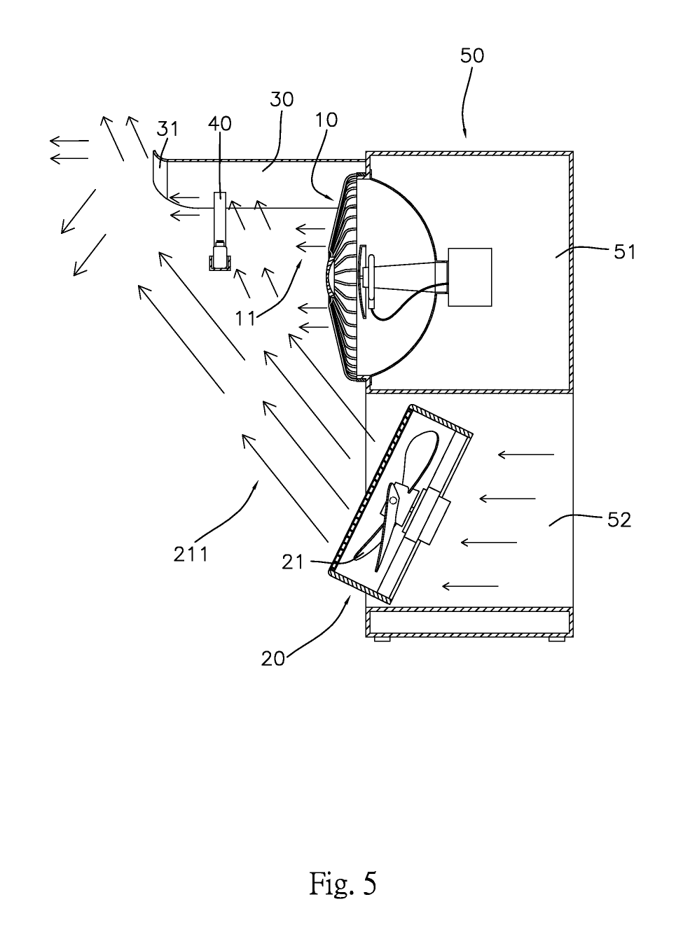

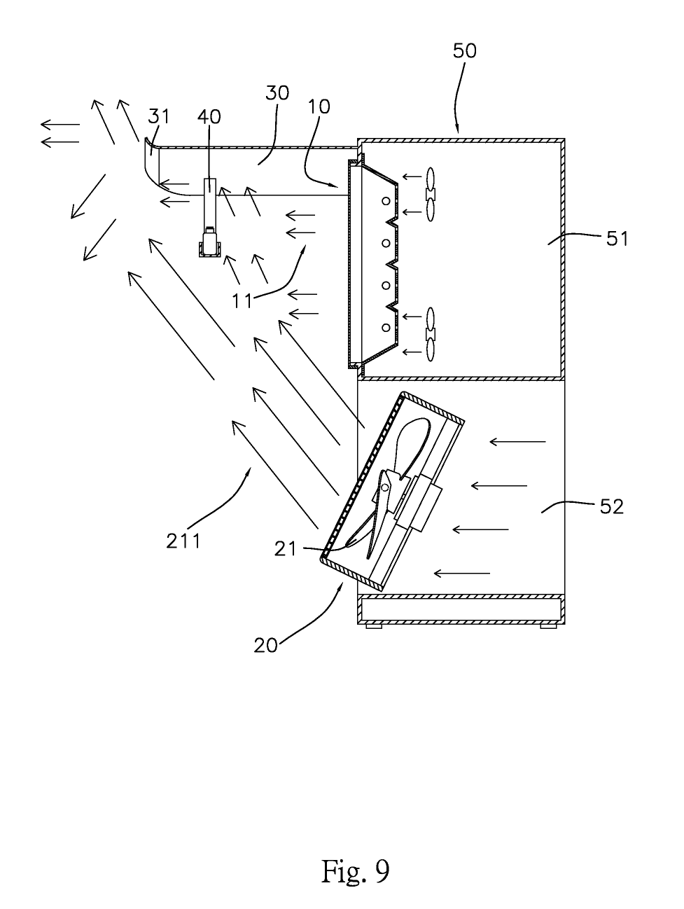

Alternatively, at the inner lower side of the wind guide 30, an essence device 40 is configured (as shown in FIGS. 5 and 9) or fixed to provide an evaporated fresher essence spreading to the farther indoor space by following the mixed heated air 11 driven by the electric fan device 20.

The above-mentioned description of the present invention has been presented for purpose of illustration and is not intended to be exhaustive or to limit the invention.

It is of course to be understood that the embodiments described herein is merely an illustration related to the principles of the invention and that a wide variety of modifications thereto may be accomplished by persons skilled in the art without departing from the scope of the invention as set forth in the following claims.

What is claimed is:

1. An electric heater structure comprises a combined configuration of an electric heater and an electric fan device both located inside a frame, and is characterized in that:
the electric fan device is configured at the lower room of the frame to bring the mixed heated air provided by the electric heater (located at the upper room of the frame) to a farther indoor space.

2. An electric heater structure according to claim 1, wherein the electric fan device is configured to be adjustable to blow out the wind field with controllable direction or angle.

3. An electric heater structure according to claim 1, wherein a wind guide is configured from the top of the electric heater and extend forward.

4. An electric heater structure according to claim 3, wherein the fore part of the wind guide is shaped as an upward front curve.

5. An electric heater structure according to claim 1, wherein an essence device is configured at the inner lower side of the wind guide.

6. An electric heater structure according to claim 1, wherein the electric heater structure is integrally configured within a whole structure and the frame is separated into an upper room and a lower room.

7. An electric heater structure according to claim 1, wherein both the upper room and the lower room is alternatively configured into an assembly of two sub-frames to form as a structural function with an electric heater at the upper room and an electric fan device at the lower room.
